(19) United States
(12) Patent Application Publication
(10) Pub. No.: US 2018/0362892 A1
(43) Pub. Date: Dec. 20, 2018

(54) SYSTEMS COMPRISING A BLEACHING AGENT AND ENCAPSULATES

(71) Applicant: The Procter & Gamble Company, Cincinnati, OH (US)

(72) Inventors: Dennis Allen BECKHOLT, Fairfield, OH (US); Nalini CHAWLA, Mason, OH (US); Mario Elmen TREMBLAY, West Chester, OH (US); Jeffrey Frank OMNITZ, Cincinnati, OH (US); Xinbei SONG, Cincinnati, OH (US)

(21) Appl. No.: 16/004,472

(22) Filed: Jun. 11, 2018

Related U.S. Application Data
(60) Provisional application No. 62/522,129, filed on Jun. 20, 2017.

(51) Int. Cl. C11D 3/39; C11D 3/50; C11D 17/00

(52) U.S. Cl. CPC C11D 3/3945; C11D 17/0039; C11D 17/0013; C11D 3/505

(57) ABSTRACT

A multi-composition system that includes a first composition having a bleaching system, and a second composition having core-in-shell encapsulates, where the shell includes acrylate material, and where the core includes a benefit agent. Related methods of treating a fabric.

### FIELD OF THE INVENTION

The present disclosure relates to a multi-composition system that includes a bleaching system and encapsulates. The present disclosure further relates to related methods of treating a fabric.

### BACKGROUND OF THE INVENTION

Bleaching agents are known to provide cleaning and malodor benefits in various types of cleaning compositions, such as laundry, automatic dishwashing, and/or hard surface cleaning compositions. For example, bleaching agents may remove malodorous soils that may otherwise undesirably impact the character of perfume deposited on a surface by the cleaning composition. However, bleaching agents can affect the stability of other active components of the cleaning composition, such as enzymes or perfumes.

Various strategies have been employed to minimize the interaction between bleaching agents and other actives. For example, dual-container systems have been proposed to keep the bleach and other actives separate during transport and storage. However, the bleaching agents and other actives still come into contact with each other during ordinary usage, such as during the wash cycle in an automatic laundry machine. As a result, the effectiveness of the active ingredients may be reduced due to degradation in the presence of the bleach, even despite the relatively short contact time.

Other strategies may include trying to protect the active ingredient from the bleach, for example by encapsulating either the bleach or the active in a protective shell. Shell materials useful for encapsulating benefit agents include melamine-formaldehyde-based polymers. Encapsulation of active agents, such as perfume, can also provide desirable long-lasting benefits, such as delayed release profiles. However, active agents in such core-in-shell encapsulates must still survive the wash and remain vulnerable to degradation in the presence of bleaching agents, which lessens the effectiveness of the active agents. For example, the active agents may leak out of the encapsulates and get degraded by the bleaching agent in a wash liquor.

There is a need for improved cleaning systems that comprise bleaching agents and encapsulated benefit agents, and related methods.

### SUMMARY OF THE INVENTION

The present disclosure relates to a multi-composition system that includes: a first composition that includes a bleaching system; and a second composition that includes core-in-shell encapsulates, where the shell includes acrylate material, and where the core includes a benefit agent.

The present disclosure also relates to a method of treating a fabric, the method including the step of contacting a fabric with a wash liquor, wherein the wash liquor includes: from about 30 ppm to about 500 ppm of a bleaching system; from about 1 ppm to about 25 ppm of core-in-shell encapsulates, where the shell includes acrylate material, and where the core includes a benefit agent; and water.

The present disclosure also relates to a method of treating a fabric, the method including the steps of: (a) contacting a fabric with a first composition that includes a bleaching system, and (b) contacting the fabric with a second composition that includes core-in-shell encapsulates, where the shell includes acrylate material, and where the core includes a benefit agent.

### BRIEF DESCRIPTION OF THE DRAWINGS

The figures herein are illustrative in nature and are not intended to be limiting.

FIG. 1 shows a cross-sectional view of a multi-container system.

FIG. 2 shows a cross-sectional view of a multi-compartment container.

FIG. 3 shows a cross-sectional view of a plurality of unit dose articles.

FIG. 4 shows a cross-sectional view of a multi-compartment unit dose article.

FIG. 5 shows an encapsulate according to the present disclosure.

FIG. 6 shows a coated encapsulate according to the present disclosure.

### DETAILED DESCRIPTION OF THE INVENTION

The present disclosure relates to cleaning systems and related methods. The cleaning systems include a bleaching agent and an encapsulated benefit agent, where the benefit agent is in a core surrounded by a shell, where the shell includes particular shell materials. More specifically, the shell material may comprise acrylate materials. In sum, in such cleaning systems, it has been found that selecting encapsulated benefit agents having particular shell materials and/or deposition aids can provide improved freshness.

It has been found that encapsulated benefit agents that include the recited shell material provide surprisingly robust benefits, even when used in a system that further includes a bleaching agent. Without wishing to be bound by theory, it is believed that the shell material of the present disclosure provides a more robust encapsulate (with less leakage of the encapsulated benefit agent) than conventional encapsulates, such as those that include melamine formaldehyde shell material, thereby effectively protecting the encapsulated benefit agent in the core from the bleaching system. Less robust encapsulates may leak benefit agent into the surrounding composition while in storage, where the leaked benefit agent may be degraded by the bleaching system when they come into contact with each other, for example, in a wash liquor.

It is also believed that the presence of deposition aids may also help to improve performance. Such deposition aids may take the form of deposition (or efficiency) polymers, which may at least partially coat an outer surface of an encapsulate. Thus, even when encapsulates do not have as robust a wall (e.g., melamine formaldehyde), thereby allowing leakage of at least some of the benefit agent, improved performance can be gained by greater deposition efficiencies.

Further, it is believed that the use of a bleaching system can improve the overall performance of the composition that includes properly selected encapsulates, for example by removing or neutralizing malodorous soils that might impact the performance or character of the encapsulated benefit agent.

Related systems, compositions, components, and methods are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, the term “solid” includes granular, powder, bar, bead, and tablet product forms.

As used herein, the term “fluid” includes liquid, gel, paste, and gas product forms.

As used herein, the term “liquid” refers to a fluid having a liquid having a viscosity of from about 1 to about 2000 mPa*s at 25° C. and a shear rate of 20 sec−¹. In some embodiments, the viscosity of the liquid may be in the range of from about 200 to about 1000 mPa*s at 25° C. at a shear rate of 20 sec−¹. In some embodiments, the viscosity of the liquid may be in the range of from about 200 to about 500 mPa*s at 25° C. at a shear rate of 20 sec−¹.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Composition

The present disclosure relates to compositions, typically multi-composition systems, that include a bleaching agent and an encapsulated benefit agent comprising a particular shell material. The encapsulated benefit agent may include a deposition aid, such as a polymer coating.

The cleaning compositions may have any desired form, including, for example, a form selected from liquid, powder, single-phase or multi-phase unit dose, pouch, tablet, gel, paste, bar, or flake.

The cleaning composition may be in the form of a fabric care composition, a dish care composition, a hard surface cleaning composition, or a combination thereof. The cleaning composition may be a fabric care composition, preferably a laundry detergent composition. The fabric care composition may be suitable for pretreatment cleaning methods, through-the-wash cleaning methods, or both.

The detergent composition may be a liquid laundry detergent. The liquid laundry detergent composition may have a viscosity from about 1 to about 2000 centipoise (1-2000 mPa·s), or from about 200 to about 800 centipoise (200-800 mPa·s). The viscosity is determined using a Brookfield viscometer, No. 2 spindle, at 60 RPM/s, measured at 25° C.

The laundry detergent composition may be a solid laundry detergent composition, and may be a free-flowing particulate laundry detergent composition (i.e., a granular detergent product).

The fabric care composition may be in unit dose form. A unit dose article is intended to provide a single, easy to use dose of the composition contained within the article for a particular application. The unit dose form may be a pouch or a water-soluble sheet. A pouch may comprise at least one, or at least two, or at least three compartments. Typically, the composition is contained in at least one of the compartments. The compartments may be arranged in superposed orientation, i.e., one positioned on top of the other, where they may share a common wall. At least one compartment may be superposed on another compartment. Alternatively, the compartments may be positioned in a side-by-side orientation, i.e., one orientated next to the other. The compartments may even be orientated in a ‘tire and rim’ arrangement, i.e., a first compartment is positioned next to a second compartment, but the first compartment at least partially surrounds the second compartment, but does not completely enclose the second compartment. Alternatively, one compartment may be completely enclosed within another compartment. A unit dose article may comprise a first composition in a first compartment, and a second composition in a second compartment, where both compositions are liquid, or where the first composition is a solid/granular composition, and the second composition is a liquid composition.

The unit dose form may comprise water-soluble film that forms the compartment and encapsulates the detergent composition. Preferred film materials are polymeric materials; for example, the water-soluble film may comprise polyvinyl alcohol. The film material can, for example, be obtained by casting, blow-moulding, extrusion, or blown extrusion of the polymeric material, as known in the art. Suitable films are those supplied by Monosol (Merrillville, Ind., USA) under the trade references M8630, M8900, M8779, and M8310, films described in U.S. Pat. No. 6,166,117, U.S. Pat. No. 6,787,512, and US2011/0188784, and PVA films of corresponding solubility and deformability characteristics.

When the fabric care composition is a liquid, the fabric care composition typically comprises water. The composition may comprise from about 1% to about 80%, by weight of the composition, water. When the composition is a heavy duty liquid detergent composition, the composition typically comprises from about 40% to about 80% water. When the composition is a compact liquid detergent, the composition typically comprises from about 20% to about 60%, or from about 30% to about 50% water. When the composition is in unit dose form, for example, encapsulated in water-soluble film, the composition typically comprises less than 20%, or less than 15%, or less than 12%, or less than 10%, or less than 8%, or less than 5% water. The composition may comprise from about 1% to 20%, or from about 3% to about 15%, or from about 5% to about 12%, by weight of the composition, water.

Multi-Composition System

The composition may be in the form of a multi-composition system. The system may include a first composition and a second composition. The first composition, the second composition, or both may be liquid compositions.

The first composition may comprise the bleaching agent, and the second composition may include the encapsulates. The first composition, the second composition, or both may further comprise adjunct materials, described below. The first, second, or both compositions may comprise a surfactant system. The second composition may comprise a surfactant composition.

The multi-composition system may be in the form of a multi-compartment system. The multi-compartment system may include a first compartment that contains the first composition, and a second compartment that contains the second composition.

As shown in FIG. 1, the multi-composition system may be in the form of a multi-container system 1. The first compartment 3 may be part of a first container 2, such as a first bottle, and the second compartment 5 may be part of a second container 4, such as a second bottle. The first and second containers may be two discrete and separable containers 2, 4, such as two distinct bottles, each with its own closure. The first container 2 may contain the first composition 6. The second container 4 may contain the second composition 7.

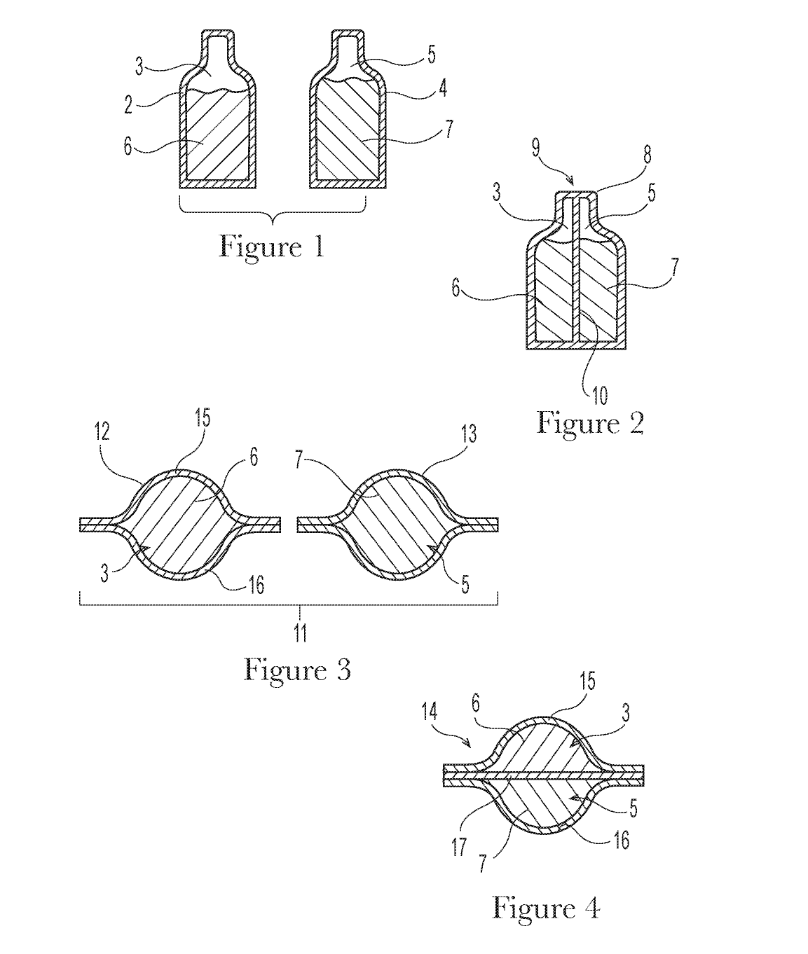

As shown in FIG. 2, the multi-compartment system may be in the form of a multi-compartment container 8, e.g., a single container that includes a first compartment 3 and a second compartment 5. The container 8 may be in the form of a multi-compartment bottle or tube, preferably in the form of a dual-compartment bottle or tube.

The multi-compartment container 8 may include an outlet 9 through which the first and second compositions 6, 7 may be dispensed from the container. The outlet 9 may be sealable by a single closure. The first and/or second compositions 6, 7 may be poured or squeezed out of the outlet 9 of the container 8.

The multi-compartment container 8 may include an interior wall 10 that separates the first and second compartments 3, 5.

The container(s) may be resealable, or may be intended for single use only. The first and/or second compositions 6, 7 may be poured or squeezed out of the container(s).

As shown in FIG. 3, the multi-compartment system may be in the form of a plurality 11 of unit dose articles, for example where a first unit dose article 12 contains the first composition 6 and the second unit dose article 13 contains the second composition 7. The first and second unit dose articles 12, 13 may be sold in a single package, or in different packages.

As shown in FIG. 4, the multi-compartment system may be in the form of a multi-compartment unit dose article 14. The article 14 may include first and second compartments 3, 5, which may be side-by-side, superposed, or in a tire-and-rim configuration.

Unit dose articles 12, 13, 14 may include water-soluble film 15, 16, 17 that encapsulate the first and/or second compositions 3, 5. Unit dose forms are described in more detail above.

Bleaching Agent

The compositions, systems, and methods of the present disclosure may include a bleaching system. The bleaching system comprises a bleaching agent, or one or more bleaching agents.

The first composition may comprise the bleaching agent. The first composition may be in the form of a liquid composition or a granular composition, preferably a liquid composition. The bleaching agent may be in the form of a slurry, containing solid particles that comprise the bleaching agent along with water and, optionally, a suspending agent and/or a chelant.

The first composition may be contained in a first compartment of a multi-compartment system, preferably in the first compartment of a multi-compartment container.

Suitable bleaching agents include photobleaches, bleach activators, hydrogen peroxide, sources of hydrogen peroxide, pre-formed peracids, bleach catalysts, and mixtures thereof.

In general, when a bleaching agent is used, the compositions of the present disclosure may comprise from about 0.1% to about 50% or even from about 0.1% to about 25% bleaching agent or mixtures of bleaching agents by weight of the subject composition. Examples of suitable bleaching agents include:

(1) photobleaches, for example sulfonated zinc phthalocyanine sulfonated aluminium phthalocyanines, xanthene dyes, thioxanthones, and mixtures thereof.

(2) pre-formed peracids. Suitable preformed peracids include, but are not limited to compounds selected from the group consisting of pre-formed peroxyacids or salts thereof typically a percarboxylic acids and salts, percarbonic acids and salts, perimidic acids and salts, peroxymonosulfuric acids and salts, for example, Oxone®, and mixtures thereof. Particularly preferred peroxyacids are phthalimido-peroxy-alkanoic acids, in particular ε-phthalimido peroxy hexanoic acid (PAP). Preferably, the peroxyacid or salt thereof has a melting point in the range of from 30° C. to 60° C.

(3) sources of hydrogen peroxide. for example, inorganic perhydrate salts, including alkali metal salts such as sodium salts of perborate (usually mono- or tetra-hydrate), percarbonate, persulphate, perphosphate, persilicate salts and mixtures thereof. When employed, inorganic perhydrate salts are typically present in amounts of from 0.05 to 40 wt %, or 1 to 30 wt % of the overall fabric and home care product and are typically incorporated into such fabric and home care products as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and

(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS).

(5) bleach catalysts. The compositions of the present disclosure may also include one or more bleach catalysts capable of accepting an oxygen atom from a peroxyacid and/or salt thereof, and transferring the oxygen atom to an oxidizeable substrate. Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and alpha amino-ketones and mixtures thereof. One particularly preferred catalyst is acyl hydrazone type such as 4-(2-(2-((2-hydroxyphenylmethyl)methylene)-hydrazinyl)-2-oxoethyl)-4-methylchloride.

(6) catalytic metal complexes. One preferred type of metal-containing bleach catalyst is a catalyst system comprising a transition metal cation of defined bleach catalytic activity, such as copper, iron, titanium, ruthenium, tungsten, molybdenum, or manganese cations.

If desired, the compositions herein can be catalyzed by means of a manganese compound. Such compounds and levels of use are well known in the art and include, for example, the manganese-based catalysts disclosed in U.S. Pat. No. 5,576,282. In some embodiments, an additional source of oxidant in the composition is not present, molecular oxygen from air providing the oxidative source.

Cobalt bleach catalysts useful herein are known, and are described, for example, in U.S. Pat. No. 5,597,936; U.S. Pat. No. 5,595,967.

When present, the source of hydrogen peroxide/peracid and/or bleach activator is generally present in the composition in an amount of from about 0.1 to about 60 wt %, from about 0.5 to about 40 wt % or even from about 0.6 to about 10 wt % based on the fabric and home care product. One or more hydrophobic peracids or precursors thereof may be used in combination with one or more hydrophilic peracid or precursor thereof.

Typically hydrogen peroxide source and bleach activator will be incorporated together. The amounts of hydrogen peroxide source and peracid or bleach activator may be selected such that the molar ratio of available oxygen (from the peroxide source) to peracid is from 1:1 to 35:1, or even 2:1 to 10:1. If formulated into a liquid detergent, the peroxide source and activator may be formulated at low pH, typically 3-5 together with a pH jump system such as borate/sorbitol.

Encapsulated Benefit Agent

The compositions, systems, and/or methods of the present disclosure may include encapsulated benefit agents, also referred to herein as “encapsulates.”

The second composition may comprise the encapsulates. The second composition may be in the form of a liquid composition or a granular composition, preferably a liquid composition. The first and the second compositions may both be liquid compositions.

The first composition may be contained in a first compartment of a multi-compartment system, preferably in the first compartment of a multi-compartment container.

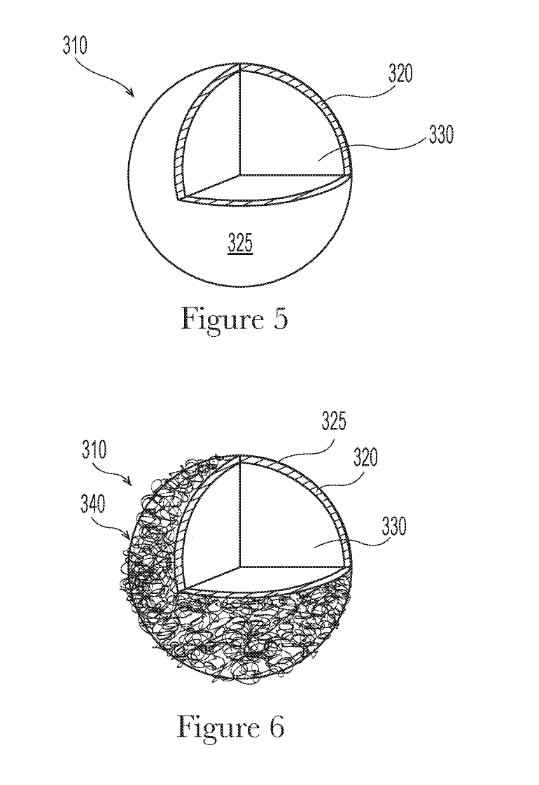

As schematically shown in FIG. 5, an encapsulate 310 may include a core 330 and a wall 320 at least partially surrounding the core 330. (As used herein, the terms “wall” and “shell” are used interchangeable with respect to encapsulates.) The core 330 may include a benefit agent, such as perfume. The wall 320 may include an outer surface 325. As schematically shown in FIG. 6, the outer surface 325 of the wall 320 may include a coating 340. The coating 340 may include a deposition aid, such as a deposition aid polymer. These elements are discussed in more detail below.

The wall of the encapsulates may include a wall material. The wall material may include an acrylate material.

The wall material may include acrylate material selected from the group consisting of a polyacrylate, a polyethylene glycol acrylate, a polyurethane acrylate, an epoxy acrylate, a polymethacrylate, a polyethylene glycol methacrylate, a polyurethane methacrylate, an epoxy methacrylate, and mixtures thereof. The wall material may include a polyacrylate polymer. The wall may include from about 50% to about 100%, or from about 70% to about 100%, or from about 80% to about 100% of a polyacrylate polymer. The polyacrylate may include a polyacrylate cross linked polymer.

The wall material of the encapsulates may include acylate material that includes a polymer derived from a material that comprises one or more multifunctional acrylate moieties. The multifunctional acrylate moiety may be selected from the group consisting of tri-functional acrylate, tetra-functional acrylate, penta-functional acrylate, hexa-functional acrylate, hepta-functional acrylate and mixtures thereof. The wall material may include a polyacrylate that comprises a moiety selected from the group consisting of an amine acrylate moiety, methacrylate moiety, a carboxylic acid acrylate moiety, carboxylic acid methacrylate moiety, and combinations thereof.

The wall material may include acrylate material that comprises one or more multifunctional acrylate and/or methacrylate moieties. The ratio of material that comprises one or more multifunctional acrylate moieties to material that comprises one or more methacrylate moieties may be from about 999:1 to about 6:4, or from about 99:1 to about 8:1, or from about 99:1 to about 8.5:1. The multifunctional acrylate moiety may be selected from the group consisting of tri-functional acrylate, tetra-functional acrylate, penta-functional acrylate, hexa-functional acrylate, hepta-functional acrylate and mixtures thereof. The wall material may include a polyacrylate that comprises a moiety selected from the group consisting of an amine acrylate moiety, methacrylate moiety, a carboxylic acid acrylate moiety, carboxylic acid methacrylate moiety and combinations thereof.

The wall material may further comprise a material selected from the group consisting of polyethylenes; polyamides; polystyrenes; polyisoprenes; polycarbonates; polyesters; acrylics; aminoplasts; polyolefins; polysaccharides, such as alginate and/or chitosan; gelatin; shellac; epoxy resins; vinyl polymers; water insoluble inorganics; silicone; and mixtures thereof.

The wall material may include an aminoplast. The aminoplast may include a polyurea, polyurethane, and/or polyureaurethane. The aminoplast may include an aminoplast copolymer, such as melamine-formaldehyde, urea-formaldehyde, cross-linked melamine formaldehyde, or mixtures thereof. The wall material may include melamine formaldehyde, and the wall may further include a coating as described below. The encapsulate may include a core that comprises perfume, and a wall that includes melamine formaldehyde and/or cross linked melamine formaldehyde. The encapsulate may include a core that comprises perfume, and a wall that comprises melamine formaldehyde and/or cross linked melamine formaldehyde, poly(acrylic acid) and poly(acrylic acid-co-butyl acrylate), and, optionally, a coating that comprises polyvinyl formamide.

The core may include a benefit agent. Suitable benefit agent may be benefit agents that provide benefits to a surface, such as a fabric. The benefit agent may be selected from the group consisting of perfume raw materials, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, fabric comfort agents, shrinkage resistance agents, stretch resistance agents, stretch recovery agents, skin care agents, glycerin, and natural actives, antibacterial actives, antiperspirant actives, cationic polymers, dyes and mixtures thereof. The benefit agent may include perfume raw materials (PRMs).

The term “perfume raw material” as used herein refers to compounds having a molecular weight of at least about 100 g/mol and which are useful in imparting an odor, fragrance, essence or scent, either alone or with other perfume raw materials. As used herein, the terms “perfume ingredient” and “perfume raw material” are interchangeable. The terms perfume raw materials may also include perfume “accords,” which typically refer to a mixture of two or more PRMs.

Typical PRM comprise inter alia alcohols, ketones, aldehydes, esters, ethers, nitrites and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The core may also comprise a partitioning modifier. Suitable partitioning modifiers may include vegetable oil, modified vegetable oil, propan-2-yl tetradecanoate and mixtures thereof. The modified vegetable oil may be esterified and/or brominated. The vegetable oil comprises castor oil and/or soy bean oil. The partitioning modifier may be propan-2-yl tetradecanoate. The partitioning modifier may be present in the core at a level, based on total core weight, of greater than 20%, or from greater than 20% to about 80%, or from greater than 20% to about 70%, or from greater than 20% to about 60%, or from about 30% to about 60%, or from about 30% to about 50%.

The encapsulates may have a volume weighted mean encapsulate size of from about 0.5 microns to about 100 microns, or from about 1 micron to about 60 microns.

The encapsulates may include a polyvinyl alcohol polymer. The polyvinyl alcohol polymer may be found in any location or region of the encapsulate that may interact with borate compounds in a finished product. For example, the polyvinyl alcohol polymer may be found in a core, a wall, an outer surface, and/or a coating of the encapsulates. The polyvinyl alcohol may be intentionally added to the encapsulates as an encapsulate component, such as a coating. The polyvinyl alcohol may be present in the encapsulates as an impurity that remains from the encapsulate-making process; for example, the polyvinyl alcohol may have been used to emulsify or suspend the main shell material as the encapsulates were manufactured.

The polyvinyl alcohol may be present in the encapsulates at a level of from about 0.5% to about 40%, or from about 0.8% to about 5%, by weight of the encapsulates. The polyvinyl alcohol polymer may be characterized by one or more of the following characteristics, as described below: hydrolysis degree, viscosity, degree of polymerization, weight average molecular weight, and/or number average molecular weight.

Suitable polyvinyl alcohol polymers may have a hydrolysis degree from about 55% to about 99%, or from about 75% to about 95%, or from about 85% to about 90%, or from about 87% to about 89%. Suitable polyvinyl alcohol polymers may have a viscosity of from about 40 cps to about 80 cps, or from about 45 cps to about 72 cps, or from about 45 cps to about 60 cps, or from about 45 cps to about 55 cps in 4% water solution at 20° C. Suitable polyvinyl alcohol polymers may be characterized by a degree of polymerization of from about 1500 to about 2500, or from about 1600 to about 2200, or from about 1600 to about 1900, or from about 1600 to about 1800. Suitable polyvinyl alcohol polymers may be characterized by a weight average molecular weight of from about 130,000 to about 204,000 Daltons, or from about 146,000 to about 186,000, or from about 146,000 to about 160,000, or from about 146,000 to about 155,000. Suitable polyvinyl alcohol polymers may be characterized by a number average molecular weight of from about 65,000 to about 110,000, or from about 70,000 to about 101,000, or from about 70,000 to about 90,000, or from about 70,000 to about 80,000 Daltons. The polyvinyl alcohol polymers found in the encapsulates of the present disclosure may have any suitable combination of these characteristics.

The encapsulate may comprise from 0.1% to 1.1%, by weight of the encapsulates, of polyvinyl alcohol. The polyvinyl alcohol may have at least one the following properties, or a mixture thereof: (i) a hydrolysis degree from 55% to 99%; (ii) a viscosity of from 40 mPa·s to 120 mPa·s in 4% water solution at 20° C.; (iii) a degree of polymerization of from 1,500 to 2,500; (iv) number average molecular weight of from 65,000 Da to 110,000 Da.

A deposition aid may at least partially coat the encapsulates, for example as a coating an outer surface of the wall of the encapsulates. Certain coatings may improve deposition of the encapsulate onto a target surface, such as a fabric. The encapsulate may have a coating-to-wall weight ratio of from about 1:200 to about 1:2, or from about 1:100 to about 1:4, or even from about 1:80 to about 1:10. The coating may comprise an efficiency polymer. The coating may be continuous or discontinuous on the outer surface of the wall.

The deposition aid may include a material selected from the group consisting of poly(meth)acrylate, poly(ethylene-maleic anhydride), polyamine, wax, polyvinylpyrrolidone, polyvinylpyrrolidone co-polymers, polyvinylpyrrolidone-ethyl acrylate, polyvinylpyrrolidone-vinyl acrylate, polyvinylpyrrolidone methylacrylate, polyvinylpyrrolidone/vinyl acetate, polyvinyl acetal, polyvinyl butyral, polysiloxane, poly(propylene maleic anhydride), maleic anhydride derivatives, co-polymers of maleic anhydride derivatives, polyvinyl alcohol, styrene-butadiene latex, gelatin, gum Arabic, carboxymethyl cellulose, carboxymethyl hydroxyethyl cellulose, hydroxyethyl cellulose, other modified celluloses, sodium alginate, chitosan, casein, pectin, modified starch, polyvinyl acetal, polyvinyl butyral, polyvinyl methyl ether/maleic anhydride, polyvinyl pyrrolidone and its copolymers, poly(vinyl pyrrolidone/methacrylamidopropyl trimethyl ammonium chloride), polyvinylpyrrolidone/vinyl acetate, polyvinyl pyrrolidone/dimethylaminoethyl methacrylate, polyvinyl amines, polyvinyl formamides, polyallyl amines and copolymers of polyvinyl amines, polyvinyl formamides, polyallyl amines and mixtures thereof. The coating may include the polyvinyl alcohol described above.

The coating may comprise a cationic efficiency polymer. The cationic polymer may be selected from the group consisting of polysaccharides, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, polyvinyl amines, polyvinyl formamides, pollyallyl amines, copolymers thereof, and mixtures thereof. The coating may comprise a polymer selected from the group consisting of polyvinyl amines, polyvinyl formamides, polyallyl amines, copolymers thereof, and mixtures thereof.

The coating may comprise polyvinyl formamide. The polyvinyl formamide may have a hydrolysis degree of from about 5% to about 95%, from about 7% to about 60%, or even from about 10% to about 40%.

One or more of the efficiency polymers may have an average molecular mass from about 1,000 Da to about 50,000,000 Da, from about 5,000 Da, to about 25,000,000 Da, from about 10,000 Da to about 10,000,000 Da, or even from about 340,000 Da to about 1,500, 000 Da. One or more of the efficiency polymers may have a charge density from about 1 meq/g efficiency polymer to about 23 meq/g efficiency polymer, from about 1.2 meq/g efficiency polymer and 16 meq/g efficiency polymer, from about 2 meq/g efficiency polymer to about 10 meq/g efficiency polymer, or even from about 1 meq/g efficiency polymer to about 4 meq/g efficiency polymer.

The core/shell encapsulate may comprise an emulsifier, wherein the emulsifier is preferably selected from anionic emulsifiers, nonionic emulsifiers, cationic emulsifiers or mixtures thereof, preferably nonionic emulsifiers.

Additional Adjuncts

The detergent compositions described herein may comprise other conventional cleaning adjuncts, such as conventional laundry adjuncts. Suitable adjuncts include builders, chelating agents, dye transfer inhibiting agents, dispersants, enzyme stabilizers, catalytic materials, bleaching agents, bleach catalysts, bleach activators, polymeric dispersing agents, soil removal/anti-redeposition agents, for example PEI600 EO20 (ex BASF), polymeric soil release agents, polymeric dispersing agents, polymeric grease cleaning agents, brighteners, suds suppressors, dyes, perfume, structure elasticizing agents, fabric softeners, carriers, fillers, hydrotropes, solvents, anti-microbial agents and/or preservatives, neutralizers and/or pH adjusting agents, processing aids, opacifiers, pearlescent agents, pigments, or mixtures thereof. Typical usage levels range from as low as 0.001% by weight of composition for adjuncts such as optical brighteners and sunscreens to 50% by weight of composition for builders. Suitable adjuncts are described in U.S. patent application Ser. No. 14/226,878, and U.S. Pat. Nos. 5,705,464, 5,710,115, 5,698,504, 5,695,679, 5,686,014 and 5,646,101, each of which is incorporated herein by reference.

The first and/or second composition may include a surfactant system. The compositions may include from about 5% to about 60%, by weight of the composition, of the surfactant system. The composition may include from about 20%, or from about 25%, or from about 30%, or from about 35%, or from about 40%, to about 60%, or to about 55%, or to about 50%, or to about 45%, by weight of the composition, of the surfactant system. The composition may include from about 35% to about 50%, or from about 40% to about 45%, by weight of the composition, of a surfactant system.

The surfactant system may include any surfactant suitable for the intended purpose of the detergent composition. The surfactant system may comprise a detersive surfactant selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material.

The surfactant system may include anionic surfactant. The anionic surfactant may include alkoxylated sulfate surfactant, which may include alkyl ethoxylated sulfate. The anionic surfactant may include anionic sulphonate surfactant, which may include alkyl benzene sulphonate, including linear alkyl benzene sulphonate.

The surfactant system may include nonionic surfactant. These can include, for example, alkoxylated fatty alcohols and amine oxide surfactants. In some examples, the surfactant system may contain an ethoxylated nonionic surfactant.

The compositions may include an external structuring system. The structuring system may be used to provide sufficient viscosity to the composition in order to provide, for example, suitable pour viscosity, phase stability, and/or suspension capabilities.

The compositions of the present disclosure may comprise from 0.01% to 5% or even from 0.1% to 1% by weight of an external structuring system. The external structuring system may be selected from the group consisting of:

(i) non-polymeric crystalline, hydroxy-functional structurants and/or

(ii) polymeric structurants.

Such external structuring systems may be those which impart a sufficient yield stress or low shear viscosity to stabilize a fluid laundry detergent composition independently from, or extrinsic from, any structuring effect of the detersive surfactants of the composition. They may impart to a fluid laundry detergent composition a high shear viscosity at 20 s⁻¹ at 21° C. of from 1 to 1500 cps and a viscosity at low shear (0.05 s⁻¹ at 21° C.) of greater than 5000 cps. The viscosity is measured using an AR 550 rheometer from TA instruments using a plate steel spindle at 40 mm diameter and a gap size of 500 μm. The high shear viscosity at 20 s⁻¹ and low shear viscosity at 0.5 s⁻¹ can be obtained from a logarithmic shear rate sweep from 0.1 s⁻¹ to 25 s⁻¹ in 3 minutes time at 21° C.

The compositions may comprise from about 0.01% to about 1% by weight of a non-polymeric crystalline, hydroxyl functional structurant. Such non-polymeric crystalline, hydroxyl functional structurants may comprise a crystallizable glyceride which can be pre-emulsified to aid dispersion into the composition. Suitable crystallizable glycerides include hydrogenated castor oil or “HCO” or derivatives thereof, provided that it is capable of crystallizing in the liquid compositions described herein.

The compositions may comprise from about 0.01% to 5% by weight of a naturally derived and/or synthetic polymeric structurant. Suitable naturally derived polymeric structurants include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. Suitable synthetic polymeric structurants include: polycarboxylates, polyacrylates, hydrophobically modified ethoxylated urethanes, hydrophobically modified non-ionic polyols and mixtures thereof. The polycarboxylate polymer may be a polyacrylate, polymethacrylate or mixtures thereof. The polyacrylate may be a copolymer of unsaturated mono- or di-carbonic acid and C₁-C₃₀ alkyl ester of the (meth)acrylic acid. Such copolymers are available from Noveon inc under the tradename Carbopol® Aqua 30.

The compositions may include enzymes. Enzymes may be included in the compositions for a variety of purposes, including removal of protein-based, carbohydrate-based, or triglyceride-based stains from substrates, for the prevention of refugee dye transfer in fabric laundering, and for fabric restoration. Suitable enzymes include proteases, amylases, lipases, carbohydrases, cellulases, oxidases, peroxidases, mannanases, and mixtures thereof of any suitable origin, such as vegetable, animal, bacterial, fungal, and yeast origin. Other enzymes that may be used in the compositions described herein include hemicellulases, gluco-amylases, xylanases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidases, chondroitinases, laccases, or mixtures thereof. Enzyme selection is influenced by factors such as pH-activity and/or stability optima, thermostability, and stability to active detergents, builders, and the like.

### Methods

The present disclosure relates to methods of using and making compositions that include a bleaching agent and encapsulated benefit agents that comprise a certain shell material.

The present disclosure relates to a method of treating a surface, such as a fabric. The method includes the steps of contacting a surface, such as a fabric, with a wash liquor. The wash liquor may include from about 30 ppm to about 500 ppm, or from about 50 ppm to about 300 ppm, of a bleaching system, from about 1 ppm to about 25 ppm, or from about 3 ppm to about 15 ppm, of core-in-shell encapsulates comprising a shell material, and water. The wash liquor may further comprise surfactant, preferably comprising anionic surfactant and/or nonionic surfactant, which may be present at a level of from about 100 ppm to about 1500 ppm, or from about 200 ppm to about 1100 ppm. Suitable bleaching agents, encapasulates, and benefit agents are described in more detail above. The bleaching system may comprise a pre-formed peroxyacid or salt thereof, preferably phthalimido-peroxy-alkanoic acids or salts thereof. The shell material may include acrylate material, which may include a polyacrylate. The benefits agent may comprise perfume raw materials.

The method may occur in an automatic laundry machine. The automatic laundry machine may be a top-loading machine or a front-loading machine. The method may occur during the wash cycle of an automatic laundry machine.

The wash liquor may have a volume of from about 10 L to about 75 L. Traditional North American top loading machine typically use about 64 L of water. High efficiency front loading machines typically use about 19 L of water. High efficiency top loading machines typically use about 25-30 L of water. Machines in Western Europe typically use about 13 L of water. Machines in Japan typically use from about 30 L to about SOL of water.

The water of the wash liquor may have an initial temperature of from about 10° C. to about 40° C., or from about 1° 5C to about 30° C.

The present disclosure also relates to a method of treating a surface, such as a fabric, where the method includes the steps of: a) contacting a surface, such as a fabric, with a first composition that includes a bleaching system, and b) contacting the fabric with a second composition that includes an encapsulated benefit agent comprising a shell material. Step a) may occur in the presence of water. Step b) may occur in the presence of water. The method may occur in an automatic laundry machine, as described above.

Steps a) and b) may occur at substantially the same time. For example, the first and second compositions may be dispensed substantially simultaneously into the drum of an automatic washing machine, for example before the wash cycle starts. The first and second compositions may be dispensed from different containers, or from a single multi-compartmented container. Prior to contacting the fabric, the first and second compositions may be contained in a multi-compartment container. Prior to contacting the fabric, the first composition may be contained in a first container, and the second composition may be contained in a second container.

Step a) may occur before step b). For example, step a) may occur during a wash cycle in an automatic washing machine, while step b) may occur during a rinse cycle in an automatic washing machine. The first and second compositions may be dispensed according to an automatic, predetermined dosing regimen of an automatic washing machine.

The compositions of the present disclosure may be used in combination with other compositions, such as fabric additives, fabric softeners, rinse aids, and the like. Additionally, the compositions of the present disclosure may be used in known hand washing methods.

The present disclosure also relates to a method of making a consumer product. The method may include the steps of providing a first composition containing a bleaching agent to a first compartment, and providing a second composition containing encapsulated benefit agents comprising a shell material to a second compartment. The first and second compartments may be sealed to allow for safe and convenient transport or storage. The first compartment and the second compartment may be part of a multi-compartmented container. The multi-compartmented container may be a unit dose article. The multi-compartmented container may be a multi-compartmented bottle.

Liquid compositions according to the present disclosure may be made according to conventional methods, for example in a batch process or in a continuous loop process. Dry (e.g., powdered or granular) compositions may be made according to conventional methods, for example by spray-drying or blow-drying a slurry comprising the components described herein

The compositions described herein may be encapsulated in a pouch, preferably a pouch made of water-soluble film, to form a unit dose article that may be used to treat fabrics. Such pouches may be made according to known methods.

### Combinations

Specifically contemplated combinations of the disclosure are herein described in the following lettered paragraphs. These combinations are intended to be illustrative in nature and are not intended to be limiting.

A. A multi-composition system comprising: a first composition comprising a bleaching system, and a second composition comprising core-in-shell encapsulates, wherein the shell comprises acrylate material, and wherein the core comprises a benefit agent.

B. The multi-composition system according to paragraph A, wherein the bleaching system comprises a pre-formed peracid, preferably comprising pre-formed peroxyacids or salts thereof, more preferably percarboxylic acids and salts, percarbonic acids and salts, perimidic acids and salts, peroxymonosulfuric acids and salts, and mixtures thereof.

C. The multi-composition system according to any of paragraphs A-B, wherein the bleaching system comprises phthalimido-peroxy-alkanoic acids, preferably ε-phthalimido peroxy hexanoic acid (PAP), or salts thereof.

D. The multi-composition system according to any of paragraphs A-C, wherein the acrylate material is selected from a polyacrylate, a polyethylene glycol acrylate, a polyurethane acrylate, an epoxy acrylate, a polymethacrylate, a polyethylene glycol methacrylate, a polyurethane methacrylate, an epoxy methacrylate, and mixtures thereof.

E. The multi-composition system according to any of paragraphs A-D, wherein the acrylate material comprises a polyacrylate.

F. The multi-composition system according to any of paragraphs A-E, wherein the polyacrylate comprises a moiety selected from the group consisting of an amine acrylate moiety, methacrylate moiety, a carboxylic acid acrylate moiety, carboxylic acid methacrylate moiety, and combinations thereof.

G. The multi-composition system according to any of paragraphs A-F, wherein the acrylate material comprises a polymer derived from one or more multifunctional acrylate moieties, preferably selected from the group consisting of tri-functional acrylate, tetra-functional acrylate, penta-functional acrylate, hexa-functional acrylate, hepta-functional acrylate, and mixtures thereof.

H. The multi-composition system according to any of paragraphs A-G, wherein the benefit agent comprises perfume raw materials.

I. The multi-composition system according to any of paragraphs A-H, wherein the core further comprises a partitioning modifier selected from the group consisting of vegetable oil, modified vegetable oil, propan-2-yl tetradecanoate, and mixtures thereof.

J. The multi-composition system according to any of paragraphs A-I, wherein the encapsulates comprise a deposition polymer at least partially coating an outer surface of the wall of the encapsulates.

K. The multi-composition system according to any of paragraphs A-J, wherein the multi-composition system is contained in a multi-compartment container, wherein the first composition is in a first compartment of the container, and wherein the second composition is in a second compartment of the container.

L. The multi-composition system according to any of paragraphs A-K, wherein the second composition further comprises from about 5% to about 60%, by weight of the second composition, of a surfactant system, the surfactant system comprising a detersive surfactant selected from anionic surfactants, nonionic surfactants, cationic surfactants, zwitterionic surfactants, amphoteric surfactants, ampholytic surfactants, and mixtures thereof.

M. The multi-composition system according to any of paragraphs A-L, wherein the first composition, the second composition, or both are liquid compositions.

N. A method of treating a fabric, the method comprising the step of contacting a fabric with a wash liquor, wherein the wash liquor comprises: from about 30 ppm to about 500 ppm of a bleaching system, from about 1 ppm to about 25 ppm of core-in-shell encapsulates, wherein the shell comprises acrylate material, and wherein the core comprises a benefit agent, and water.

O. The method according to paragraph N, wherein: the bleaching system comprises a pre-formed peroxyacid or salt thereof, preferably phthalimido-peroxy-alkanoic acids or salts thereof, the acrylate material comprises a polyacrylate, and the benefits agent comprises perfume raw materials.

P. A method of treating a fabric, the method comprising the steps of: (a) contacting a fabric with a first composition comprising a bleaching system (e.g., as according to any of paragraphs A-M), and (b) contacting the fabric with a second composition comprising core-in-shell encapsulates, wherein the shell comprises acrylate material, and wherein the core comprises a benefit agent (e.g., as according to any of paragraphs A-M).

Q. The method according to paragraph P, wherein the bleaching system comprises a pre-formed peroxyacid or salt thereof.

R. The method according to any of paragraphs P-Q, wherein steps a) and b) occur at substantially the same time.

S. The method according to any of paragraphs P-R, wherein, prior to contacting the fabric, the first and second compositions are contained in a multi-compartment container.

T. The method according to any of paragraphs P-S, wherein, prior to contacting the fabric, the first composition is contained in a first container, and wherein the second composition is contained in a second container.

V. A multi-composition system comprising: a first composition comprising a bleaching system, and a second composition comprising core-in-shell encapsulates, wherein the shell comprises a coating, which preferably comprises a cationic polymer such as polyvinyl formamide, optionally wherein the shell comprises an aminoplast such as melamine formaldehyde; and wherein the core comprises a benefit agent, such as perfume raw materials, and otherwise wherein the multi-composition system and related methods are as described in any of paragraphs A-T.

### Test Methods

### Method for Determining Volume Weighted Mean Encapsulate Size

Encapsulate size is measured using an Accusizer 780A, made by Particle Sizing Systems, Santa Barbara Calif. The instrument is calibrated from 0 to 300 μm using Duke particle size standards. Samples for encapsulate size evaluation are prepared by diluting about 1 g emulsion, if the volume weighted mean encapsulate size of the emulsion is to be determined, or 1 g of capsule slurry, if the finished capsule volume weighted mean encapsulate size is to be determined, in about 5 g of de-ionized water and further diluting about 1 g of this solution in about 25 g of water.

About 1 g of the most dilute sample is added to the Accusizer and the testing initiated, using the autodilution feature. The Accusizer should be reading in excess of 9200 counts/second. If the counts are less than 9200 additional sample should be added. The accusizer will dilute the test sample until 9200 counts/second and initiate the evaluation. After 2 minutes of testing the Accusizer will display the results, including volume-weighted median size.

The broadness index can be calculated by determining the encapsulate size at which 95% of the cumulative encapsulate volume is exceeded (95% size), the encapsulate size at which 5% of the cumulative encapsulate volume is exceeded (5% size), and the median volume-weighted encapsulate size (50% size—50% of the encapsulate volume both above and below this size). Broadness Index (5)=((95% size)−(5% size)/50% size).

### EXAMPLES

The examples provided below are intended to be illustrative in nature and are not intended to be limiting.

### Example 1. Preparation of an Encapsulate Slurry

An encapsulate slurry may be prepared according to the following procedure.

An oil solution, consisting of 150 g Fragrance Oil, 0.6 g DuPont Vazo-52, and 0.4 g DuPont Vazo-67, is added to a 35° C. temperature controlled steel jacketed reactor, with mixing at 1000 rpm (4 tip, 2″ diameter, flat mill blade) and a nitrogen blanket applied at 100 cc/min. The oil solution is heated to 75° C. in 45 minutes, held at 75° C. for 45 minutes, and cooled to 60° C. in 75 minutes.

A second oil solution, consisting of 37.5 g Fragrance Oil, 0.5 g tertiarybutylaminoethyl methacrylate, 0.4 g 2-carboxyethyl acrylate, and 19.5 g Sartomer CN975 (hexafunctional aromatic urethane-acrylate oligomer) is added when the first oil solution reached 60° C. The combined oils are held at 60° C. for an additional 10 minutes.

Mixing is stopped and a water solution, consisting of 112 g 5% Celvol 540 polyvinyl alcohol, 200 g water, 1.1 g 20% NaOH, and 1.17 g DuPont Vazo-68WSP, is added to the bottom of the oil solution, using a funnel.

Mixing is again started, at 2500 rpm, for 60 minutes to emulsify the oil phase into the water solution. After milling is completed, mixing is continued with a 3″ propeller at 350 rpm. The batch is held at 60° C. for 45 minutes, the temperature is increased to 75° C. in 30 minutes, held at 75° C. for 4 hours, heated to 90° C. in 30 minutes and held at 90° C. for 8 hours. The batch is then allowed to cool to room temperature.

The resulting encapsulates in the slurry have a median encapsulate size of about 5-20 microns. The encapsulates comprise about 10%, by weight of the encapsulates, of wall material, and about 90%, by weight of the encapsulates, of core material.

### Example 2. Comparisons of Encapsulates in the Presence of PAP

In Examples 2 and 3, the following nomenclature is used:
Encapsulate 1: a core-in-shell capsule, containing perfume raw materials in the core, and having a melamine-formaldehyde-based shell, coated with polyvinyl formamide polymer as a deposition aid
Encapsulate 2: a core-in-shell capsule, containing perfume raw materials in the core, and having an acrylate-polymer-based shell
PAP: ε-phthalimido peroxy hexanoic acid

In the following tests, the performances of Encapsulates 1 and 2 are compared, as determined by an expert perfumer with regard to dry fabric odor (DFO), pre-rub and post-rub. The performance is determined in wash cycles (North American front-loading machine) that include a base detergent composition, with and without PAP. For each leg, both encapsulates are present in the wash liquor at a level of 20 ppm, and PAP (if present) is present in the wash liquor at about 270 ppm. For each leg, two trials are run, with the fabric from one trial being tumble-dried in an automatic drying machine, and the fabric from the other trial being air-dried. The results from the tumble-dried trials appear nearly equal for each leg, but the results from the air-dried trials are shown below in Table 1. For each data point of an encapsulate in combination with PAP, the difference (Δ) from the parallel non-PAP leg is also shown, as are differences comparing the two PAP legs (legs 2 and 4).

For DFO scores, a difference of 5 is considered directionally different, and a difference of 10 is considered to be consumer-noticeable.

TABLE 1

| | | | DFO (pre-rub; | DFO (post-rub; |
|---|---|---|---|---|
| Leg | Encapsulate (ppm) | PAP? | air-dried) | air-dried) |
| 1 | Encapsulate 1 | No | 47.5 | 60 |
| (comp) | (20 ppm) | | | |
| 2 | Encapsulate 1 | Yes | 50 | 62.5 |
| (comp) | (20 ppm) | | (Δ vs. 1 = 2.5) | (Δ vs. 1 = 2.5) |
| 3 | Encapsulate 2 | No | 45 | 60 |
| (comp) | (20 ppm) | | | |
| 4 | Encapsulate 2 | Yes | 52.5 | 70 |
| | (20 ppm) | | (Δ vs. 3 = 7.5; | (Δ vs. 3 = 10; |
| | | | Δ vs. 2 = 2.5) | Δ vs. 2 = 7.5) |

As shown in Table 1, the performance on air-dried fabric of Encapsulates 1 and 2, without the presence of PAP, is approximately equal (compare Legs 1 and 3). However, in the presence of PAP, Encapsulate 2 performs better than Encapsulate 1 (see Leg 4, A vs. 2) on air-dried fabrics. Furthermore, the results of Leg 4 (Encapsulate 2+PAP) show a relative greater increase in DFO (pre- and post-rub) compared to Leg 3 (Δ vs. 3) than is shown by comparing Leg 2 to Leg 1 (Δ vs. 1).

### Example 3. Levels Comparison

In the following examples, the performances of Encapsulates 1 and 2 were compared, as determined by an expert perfumer with regard to dry fabric odor (DFO), pre-rub and post-rub. The performance was determined in wash cycles (North American front-loading machine) that included a base detergent composition, with and without PAP. For each leg, Encapsulate 1 was present in the wash liquor at a level of 10 ppm, Encapsulate 2 was present in the wash liquor at a level of 2 ppm, and PAP (if present) was present in the wash liquor at about 270 ppm. For each leg, two trials were run, and the averaged results for each leg are shown below in Table 2.

For DFO scores, a difference of 5 is considered directionally different, and a difference of 10 is considered to be consumer-noticeable.

TABLE 2

| | | | | DFO |
|---|---|---|---|---|
| Leg | Encapsulate (ppm) | PAP? | DFO (pre-rub) | (post-rub) |
| 1 | Encapsulate 1 (10 ppm) | No | 28.75 | 40 |
| (comp) | | | | |
| 2 | Encapsulate 1 (10 ppm) | Yes | 32.5 | 40 |
| (comp) | | | | |
| 3 | Encapsulate 2 (2 ppm) | No | 23.75 | 32.5 |
| (comp) | | | | |
| 4 | Encapsulate 2 (2 ppm) | Yes | 26.25 | 33.75 |

As shown by the data in Table 2, Encapsulate 2 provides DFO scores less than 10 points different (i.e., considered not to be a consumer-noticeable difference) from those provided by Encapsulate 1, despite the fact that Encapsulate 2 is present in the wash liquor at a level five times less than the level of Encapsulate 1.

Encapsulates such as Encapsulate 2 that offer suitable performance benefits at lower concentrations than other encapsulates may be particularly preferred for cost-related reasons (as less is required to offer a similar benefit) and/or in compact formulations (where formulation space is limited).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any disclosure disclosed or claimed herein or that it alone, or in any combination with any other reference or references, teaches, suggests or discloses any such disclosure. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A multi-composition system comprising:
a first composition comprising a bleaching system, and
a second composition comprising core-in-shell encapsulates,
wherein the shell comprises acrylate material, and
wherein the core comprises a benefit agent.

2. The multi-composition system according to claim 1, wherein the bleaching system comprises a pre-formed peracid,
preferably comprising pre-formed peroxyacids or salts thereof,
more preferably percarboxylic acids and salts, percarbonic acids and salts, perimidic acids and salts, peroxymonosulfuric acids and salts, and mixtures thereof.

3. The multi-composition system according to claim 1, wherein the bleaching system comprises phthalimido-peroxy-alkanoic acids, preferably ε-phthalimido peroxy hexanoic acid (PAP), or salts thereof.

4. The multi-composition system according to claim 1, wherein the acrylate material is selected from a polyacrylate, a polyethylene glycol acrylate, a polyurethane acrylate, an epoxy acrylate, a polymethacrylate, a polyethylene glycol methacrylate, a polyurethane methacrylate, an epoxy methacrylate, and mixtures thereof.

5. The multi-composition system according to claim 1, wherein the acrylate material comprises a polyacrylate.

6. The multi-composition system according to claim 5, wherein the polyacrylate comprises a moiety selected from the group consisting of an amine acrylate moiety, methacrylate moiety, a carboxylic acid acrylate moiety, carboxylic acid methacrylate moiety, and combinations thereof.

7. The multi-composition system according to claim 1, wherein the acrylate material comprises a polymer derived from one or more multifunctional acrylate moieties,
preferably selected from the group consisting of tri-functional acrylate, tetra-functional acrylate, penta-functional acrylate, hexa-functional acrylate, hepta-functional acrylate, and mixtures thereof.

8. The multi-composition system according to claim 1, wherein the benefit agent comprises perfume raw materials.

9. The multi-composition system according to claim 1, wherein the core further comprises a partitioning modifier selected from the group consisting of vegetable oil, modified vegetable oil, propan-2-yl tetradecanoate, and mixtures thereof.

10. The multi-composition system according to claim 1, wherein the encapsulates comprise a deposition polymer at least partially coating an outer surface of the wall of the encapsulates.

11. The multi-composition system according to claim 1, wherein the multi-composition system is contained in a multi-compartment container, wherein the first composition is in a first compartment of the container, and wherein the second composition is in a second compartment of the container.

12. The multi-composition system according to claim 1, wherein the second composition further comprises from about 5% to about 60%, by weight of the second composition, of a surfactant system,
the surfactant system comprising a detersive surfactant selected from anionic surfactants, nonionic surfactants, cationic surfactants, zwitterionic surfactants, amphoteric surfactants, ampholytic surfactants, and mixtures thereof.

13. The multi-composition system according to claim 1, wherein the first composition, the second composition, or both are liquid compositions.

14. A method of treating a fabric, the method comprising the step of contacting a fabric with a wash liquor, wherein the wash liquor comprises:
from about 30 ppm to about 500 ppm of a bleaching system,
from about 1 ppm to about 25 ppm of core-in-shell encapsulates,
wherein the shell comprises acrylate material, and
wherein the core comprises a benefit agent, and
water.

15. The method according to claim 14, wherein:
the bleaching system comprises a pre-formed peroxyacid or salt thereof, preferably phthalimido-peroxy-alkanoic acids or salts thereof,
the acrylate material comprises a polyacrylate, and
the benefits agent comprises perfume raw materials.

16. A method of treating a fabric, the method comprising the steps of:
a) contacting a fabric with a first composition comprising a bleaching system, and
b) contacting the fabric with a second composition comprising core-in-shell encapsulates,
wherein the shell comprises acrylate material, and
wherein the core comprises a benefit agent.

17. The method according to claim 16, wherein the bleaching system comprises a pre-formed peroxyacid or salt thereof.

18. The method according to claim 16, wherein steps a) and b) occur at substantially the same time.

19. The method according to claim 16, wherein, prior to contacting the fabric, the first and second compositions are contained in a multi-compartment container.

20. The method according to claim 16, wherein, prior to contacting the fabric, the first composition is contained in a first container, and wherein the second composition is contained in a second container.
